(19) United States
(12) Patent Application Publication
(10) Pub. No.: US 2012/0329029 A1
(43) Pub. Date: Dec. 27, 2012

(54) COMPUTER IMPLEMENTED TEACHING METHOD AND APPARATUS

(76) Inventor: Mihai Catalin RAUTA, Rockville, MD (US)

(21) Appl. No.: 13/167,685

(22) Filed: Jun. 23, 2011

(51) Int. Cl. G09B 7/00

(52) U.S. Cl. 434/350; 434/362

(57) ABSTRACT

A computer implemented method for teaching subject matter includes the steps of generating an assignment including one or more questions, providing the assignment to one or more students, recording a final answer to each of the one or more questions and one or more steps taken to reach the final answer, and grading the assignment. A computer implemented system of teaching subject matter to one or more students includes an assignment generating station operable to generate an assignment including one or more questions, a testing station operable to administer the assignment to one or more students and record an answer to each of the one or more questions and steps taken to reach the answer, and a grading station operable to grade the answer and steps taken to reach the answer.

### BACKGROUND

Traditionally, students are taught in a classroom setting in which responses to homework and tests are handwritten and then graded by a teacher. The teacher can then set the curriculum based on how an individual student and/or a class performs. The teacher, particularly in mathematics, can grade the steps taken to reach each answer. By viewing the steps taken to reach an answer, conceptual errors can be pinpointed. However, grading each step can be tedious and time consuming, particularly in grading more complex problems. Thus, many teachers do not grade each step. In addition, the review by a skilled teacher can provide an indication of a student's progress over time and identify areas requiring further emphasis and development.

Moreover, with the popularity of distance learning, the student and/or class can complete assignments on a computer and the computer can generate grades. However, it can be difficult to pinpoint weaknesses in a student's understanding because computer generated grading has failed to look at the steps the student is taking to arrive at the answers given and has provided grading based only on a final answer. Such computer implemented programs also fail to predict future performance, which can be important data as schools prepare for standardized testing, make suggestions for how teachers can improve the instruction they provide, and/or make suggestions as to how individual students should proceed in their education.

As such, a computer implemented teaching method and apparatus that allows for the predictions of how of an individual student, or groups of students, may perform and that allows teachers, administrators and parents to pinpoint where errors are occurring by looking at the steps taken to reach an answer is desirable, because such a system more closely replicates the functions performed by individual teachers but in a more efficient and less time consuming manner. Such a system and method also desirably aids in determining weaknesses in teaching methods and/or the curriculum, and also aids in suggesting improvements in the curriculum to rectify the weaknesses.

### SUMMARY

Exemplary embodiments are directed to a computer implemented teaching method and apparatus for teaching various subjects, in particular mathematics.

In a preferred embodiment, a computer implemented method for teaching subject matter comprises: generating an assignment including one or more questions in an assignment generating station; providing the assignment to one or more students via a testing station; recording a final answer to each of the one or more questions and one or more steps taken to reach the final answer at the testing station; grading the assignment in a computer implemented grading station; and optionally generating an assignment report in a computer implemented assignment reporting station. In the preferred embodiment, the grading step includes grading the one or more steps taken to reach the answer and the final answer. The grading of steps can occur by comparing each step to correct steps contained in a steps and answers database. In a particular embodiment, the method can include providing the assignment report to one or more of a teacher, an administrator and a parent.

Preferably, the method can also include generating a future performance prediction report and providing a future performance prediction report to one or more of a teacher, an administrator, and a parent. Moreover, the method can include adjusting the curriculum based on the assignment report and/or adjusting the curriculum based on the future performance prediction report.

Also preferably, the assignment is a test, a quiz, homework, or compilation of practice questions. Preferably, the generating step includes uploading a set of questions to a testing station and selecting a subset of questions for inclusion in the assignment. Alternatively, a complete set of uploaded questions can be included in a single assignment.

In another embodiment, a computer implemented apparatus for teaching subject matter to one or more students comprises: an assignment generating station operable to generate an assignment including one or more questions, a testing station operable to administer said assignment to one or more students and record an answer to each of the one or more questions and steps taken to reach the answer, a grading station operable to grade the answer and steps, and an assignment reporting station operable to generate an assignment report.

In the preferred embodiment, the apparatus can also include a future performance prediction (FPP) station operable to predict future performance based on the assignment report. Preferably, the system can also include a curriculum and assignment adjustment station operable to adjust student instruction and future assignments.

In a particular embodiment, the testing station can include a personalization engine, which can be used to personalize the settings of the testing station based on the student's choices. Alternatively, teachers, parents and/or administrators can change the personalization settings of the personalization engine.

In another preferred embodiment, a computer executable program stored on a computer readable medium for use in a computer that provides assignments to students for completion electronically, the computer program product makes the computer execute the process comprising the steps of: generating an assignment including one or more questions in an assignment generating station; providing the assignment to one or more students at a testing station; recording a final answer to each of the one or more questions and one or more steps taken to reach the final answer; and grading the assignment including the final answer and each of the one or more steps at a grading station.

### BRIEF DESCRIPTION OF THE DRAWINGS

FIG. 1 is a flow chart illustrating an apparatus for teaching subject matter.

FIG. 2 is a schematic illustration of an exemplary system for teaching subject matter.

FIG. 3 is a flow chart of a first embodiment of a method for teaching subject matter to an individual student.

FIG. 4 is a flow chart of a second embodiment of a method for teaching subject matter to multiple students.

FIG. 5 is an exemplary display of the assignment report showing progress of classes of students, by teacher, based on class.

FIG. 6 is an exemplary display of the assignment report showing progress of schools and school districts as compared to core standards.

FIG. 7 is an exemplary display of the assignment report showing progress of individual students.

FIG. 8 is an exemplary display of the assignment report showing details of progress across students.

FIG. 9 is an exemplary display of the assignment report showing progress of students for a topic/subtopic area.

FIG. 10 is an exemplary display of the assignment report showing projected gaps for select students and subtopics.

FIG. 11 is an exemplary display showing a grade book view of a group of students.

FIGS. 12A, 12B, 12C, 12D, 12E, 12F, 12G, 12H, 12I, 12J, 12K, 12L, 12M, 12N, 12O, 12P, and 12Q illustrate an exemplary displays depicting a long division math problem as part of a pirate themed game.

FIG. 13 is an exemplary display of a report showing grades based on steps taken to reach an answer as described herein.

### DETAILED DESCRIPTION

The method and apparatus described herein may address one or more of the problems as discussed above. However, it is contemplated that the method and apparatus may prove useful in addressing other problems and deficiencies, or provide other benefits and advantages. Therefore the claimed method and apparatus should not necessarily be construed as limited to addressing any of the particular problems or deficiencies discussed herein.

As used herein, the term “computer” describes an electronic device for storing and processing data based on instructions provided thereto. Preferably, the computer includes a memory and processor. Exemplary computers include, without limitation, personal computers, laptop computers, gaming systems, tablet computers, personal digital assistants, smart phones, stationary and/or portable computers, mini computers, super computers, a server, a client, an interactive television, a web appliance, a telecommunications device with internet access, any device that may accept and process data in accordance with stored software and which may generate and store results, and the like.

As used herein, the term “software” describes a set of rules for operating a computer or portion thereof. Exemplary software includes, without limitation, code segments, instructions, computer programs, programmed logic, applets, pre-compiled cord, compiled code, interpreted code, and the like.

As used herein, the term “hardware” describes physical parts of a computer, computer system and/or network including, without limitation, central processing units, random access memory, video display controller, computer bus, disk drives, motherboard, basis input output systems, firmware, networking hardware components, flash drives, modems, webcam, keyboards, and the like.

As used herein, the term “memory” describes computer readable and/or writeable media including, without limitation, memory sticks, hard drives, CD-ROM, DVD, floppy disk, magnetic tape, memory chip, and/or any other type of memory that can store data, software, and/or instructions for use with a computer.

As used herein, the terms “subjects” and “subject matter” refers to a course or area for study. Exemplary subjects and/or subject matter includes, without limitation, mathematics, science, reading, English, foreign languages, social studies, history, art, music and/or music theory, writing, literature, psychology, and the like.

As used herein, the term “assignment” describes homework, practice questions, quizzes, tests, projects, and the like, which are assigned, generated, and/or provided to a student by a teacher, parent, administrator, and/or the apparatus described herein. The term assignment can also describe standardized tests such as state and national tests.

As used herein, the term “teacher” describes teachers, tutors, and other individuals directly involved in instructing students including, where applicable, family members of the student.

As used herein, the term “administrator” describes principals, vice principals, school board members, deans, curriculum specialists, academic officers, superintendents, chancellors, and other individuals who oversee a learning program, but do not directly instruct students.

As used herein, the terms “network” and/or “computer network” refers to two or more computers connected by communication channels that facilitate communication and/or sharing of information between users. Suitable networks include, without limitation, local area networks (LAN), wide area networks (WAN), internet, intranet, virtual private networks (VPN), wireless networks, and combinations thereof.

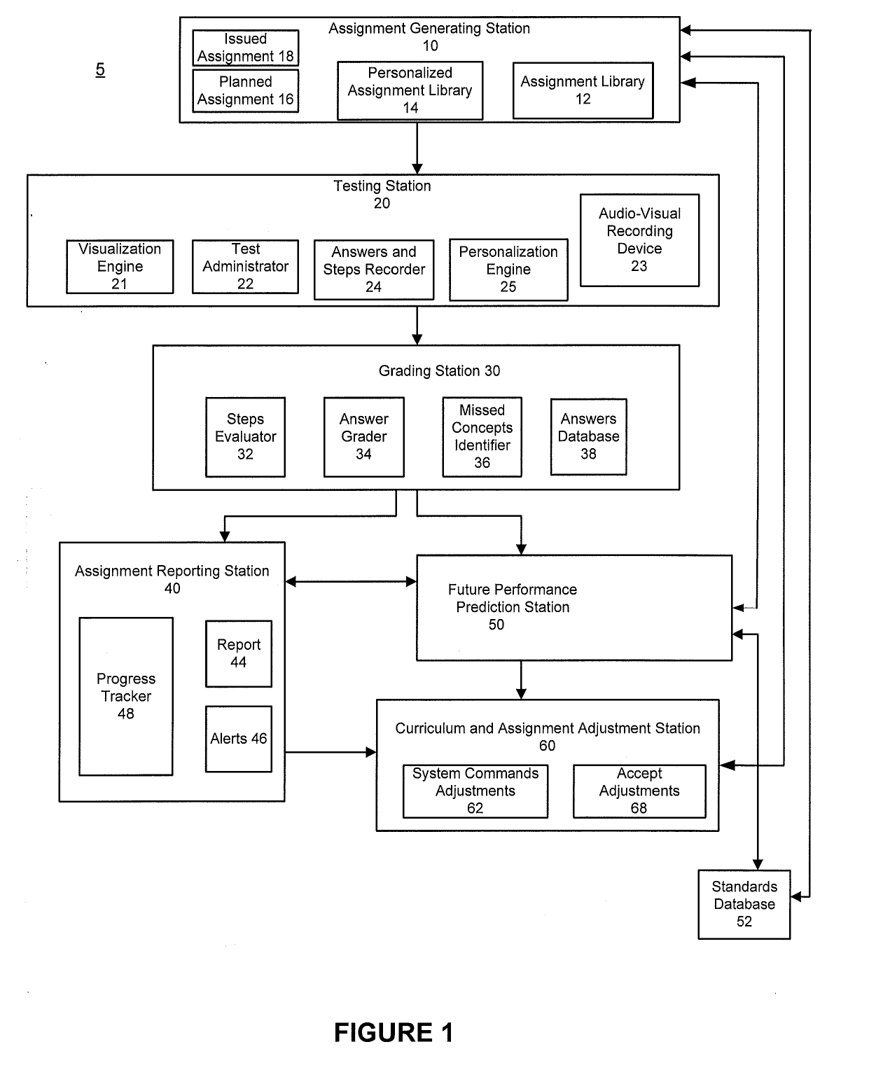

In a preferred embodiment, as shown in FIG. 1, an apparatus 5 for teaching subject matter allows teachers, parents and/or administrators to provide computerized assignments to students, which the students can complete and store at a testing station. It is contemplated that the apparatus and method described herein are useful in traditional classroom settings, at home and/or in hybrid learning environments.

As shown in FIG. 1, in the preferred embodiment, the apparatus 5 includes software and/or hardware modules including an assignment generating station 10 comprising a memory and operable to provide an assignment including at least one question for completion by a student. The assignment generating station 10 can also include software and/or hardware modules including a microprocessor for selecting one or more questions to include in an assignment. Preferably, the apparatus 5 also includes software and/or hardware modules including at least one testing station 20 operable to administer the assignment and save the completed assignment. Also preferably, the apparatus 5 includes software and/or hardware modules including a grading station 30 operable to grade a completed assignment, an assignment reporting station 40 operable to generate a report based on the student's performance, a future performance prediction (FPP) station 50 operable to predict the student's future performance, and a curriculum and assignment adjustment station 60 operable to adjust and/or make suggestions regarding adjustment of the curriculum and/or assignments based on reports generated by the assignment reporting station 40 and the FPP station 50.

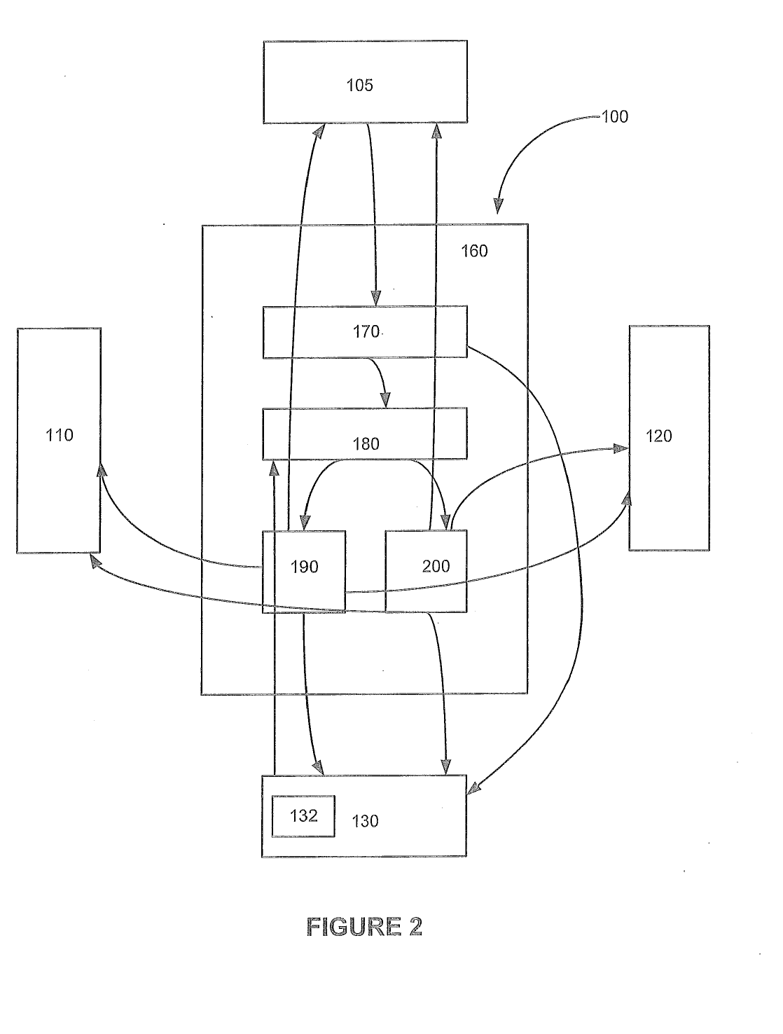

Preferably, the apparatus 5 includes various software and/or hardware components including memory where necessary to save assignments, completed assignments, and/or reports. Moreover, the assignment generating station 10, the testing station 20, the grading station 30, the assignment reporting station 40, the FPP station 50 and/or the curriculum and assignment adjusting station 60 can be parts of a virtual learning environment and/or the stations 10, 20, 30, 40, 50, 60 can be in communication via a network, such as a LAN or the internet. For example, the stations 10, 20, 30, 40, 50, 60 can be software components loaded onto a single computer or multiple computers. Alternatively, the stations 10, 20, 30, 40, 50, 60 can be loaded on a server that can be accessed by one or more computers as shown in FIG. 2. In another embodiment, each station 10, 20, 30, 40, 50, 60 can be housed on a separate computer and the assignment, completed assignment, reports and other information can be saved and/or transmitted, via a network, to the other stations 10, 20, 30, 40, 50, 60 for completion of the assignment, grading of the assignment, and generating reports based on the completed assignment.

As shown in FIG. 1, the assignment generating station 10, testing station 20, grading station 30, assignment reporting station 40, FPP station 50 and/or curriculum and assignment adjustment station 60 can be run on the same or different computers. For example, if the assignment generating station 10, testing station 20 and the grading station 30 are on different computers, the issued assignment can be transmitted over a network to the testing station where the assignment is completed. The completed assignment may then be transmitted over a network, such as a LAN or the internet, for grading at a grading station 30 or may be saved and uploaded at the grading station 30.

In the preferred embodiment, as shown in FIG. 1, the assignment generating station 10 can include various software and/or hardware modules including a planned assignment 16, an issued assignment 18, a personalized assignment library 14, and/or an assignment library 12. A teacher, administrator, and/or parent can upload a planned assignment 16 to the assignment generating station 10 and/or save assignments to the personalized assignment library 14. Moreover, teachers, administrators and/or parents can submit assignments to the assignment library 12. Once the planned assignment 16 is assigned to one or more students, the planned assignment can be saved as an issued assignment 18, transmitted to the testing station 20 and put in queue for student completion at the testing station 20. Preferably, the assignment generating station 10 also includes an optional personalized assignment library 14 and an assignment library 12. Preferably, the planned and/or issued assignment can include one or more questions uploaded by the teacher or incorporated from the personalized assignment library 14 and/or the assignment library 12. Moreover, the assignments in the personalized assignment library 14 and/or the assignment library 12 can be modified, edited and/or saved by the teacher, parent and/or administrator as necessary.

In addition, the questions in the planned assignment 16 can be included in the assignment library 12 as individual questions and/or groups of questions which are stored electronically for later use. The questions can be grouped by topic, subtopic and/or concept and the library 12 can be searched electronically to locate suitable questions based on topic, subtopic and/or concept. Thus, the questions in the assignment library 12 can be shared amongst multiple teachers, classes, schools, and/or school districts for use in other assignment plans. The assignment library 12 can also include expected student performance and/or improvement for each assignment saved therein based on comparisons to the standards database, previous reports, and recommendations made by the curriculum and assignment adjustment station 60.

In one embodiment, administrators can view the assignment library 12 and compare assignments of one teacher with those of another. This can provide particularly helpful information when one teacher appears to be more successful as evidenced by higher student grades and/or performance. The assignment library 12, personalized assignment library 14, planned assignment 16, and issued assignment 18 can also catalog dates and time when an assignment has been and/or will be issued and due.

In one embodiment, the teacher can choose a subset of the questions stored electronically in the assignment library 12 for use in the planned assignment 16 or for inclusion in the personalized assignment library 14. Preferably, the personalized assignment library 14 can include a subset of questions preferred by the teacher and each teacher using the apparatus 5 can have a personalized assignment library 14 within the apparatus 5. Thus, the teacher has the ability to tailor an assignment plan to a particular student or groups of students based on actual progress and/or projected progress as reported by the assignment reporting station 40 and the future performance prediction station 50. Optionally, the apparatus 5 can be instructed to automatically tailor the assignment issued to one or more students based on criteria such as grade level, level of mastery, progress within the method and apparatus, etc.

In lieu of uploading a complete planned assignment 16, the assignment generating station 10 can be instructed to provide the full set of questions as an issued assignment plan 18 or can be programmed to choose a subset of questions from either the personalized assignment library 14 or the assignment library 12 as an issued assignment 18 to be completed by one or more students. Once an assignment is selected as an issued assignment 18, the issued assignment 18 can be accessed by one or more students via a network and/or server. For example, a student may log into a server, locate the assignment and complete the assignment. Alternatively, the issued assignment 18 can be transmitted over a network to the testing station 20 for student completion.

In the preferred embodiment, the testing station 20 is operable to personalize the assignment completion experience, administer assignments and/or save completed assignments. Preferably, the testing station 20 includes a personalization engine 25 in which the student can personalize the user interface of the testing station 20, which can include a computer. Thus, the student can enter their preferences as to screen colors, assign an avatar, generate the questions in a game setting, and/or change the theme of the assignment. In one embodiment, the theme can be selected for not only completion of the assignment, but for the overall experience of the student for the duration of use of the apparatus 5. For example, the student may choose to associate math questions with a pirate theme and thus the math questions can include counting, adding, subtracting, multiplying and dividing theme-related items such as pirate “gold” based on the skill level of the student. Moreover, the student may choose to the complete the assignment as part of a game, for example, a hunt for gold coins that must be counted to reach the final answer, or extended adventures spanning multiple assignments.

Preferably, the personalization applies to all aspects of the look and experience of the student. Thus, when selecting a theme through the personalization engine 25, the avatar, objects being counted, multiplied, divided, manipulated and visualized (e.g., gold coins, cupcakes, butterflies, and the like), the containers used to hold objects (e.g, treasure chests, ships, baking ovens, butterfly nets, and the like), and the tools used to perform operations and manipulate objects (e.g, pirate hook hand, oven mitt, and the like), and/or the adventures that accompany the assignments, goals and rewards are altered to fit with the selected theme.

In an alternative embodiment, the assignments can be completed without a theme, or the testing station may provide the student with an option to use a theme or not.

Preferably, students can also select their preferred language (e.g., French, English, German, Dutch, Japanese, Chinese, Spanish, Portuguese, Italian, Russian, Farsi, Arabic, Korean, etc.) via the personalization engine 25. Moreover, students can select other students to be on their “team” via the personalization engine 25 so that assignments can be completed in groups thereby qualifying them to engage in joint games, goals and rewards. Teachers, parents, and/or administrators can control when the student engages in collaborative/team work or when the student completes each assignment as a game with a theme. Moreover, teachers, parents, and/or administrators should be able to specify team controls for specific questions within assignments, or for entire assignments as a whole, or for an entire course.

In the preferred embodiment, the testing station 20 also includes software and/or hardware modules including a visualization engine 21 which allows the student to depict the specific steps within the problem both visually and/or numerically, including the ability to interact with and manipulate objects rendered in the system so that the student can show the steps taken (e.g, line up two butterflies and two frogs to add 2+2) and the system can record the steps in addition to the answer given. Preferably, the visualization engine 21 can be instructed allow visualization of objects so that the student can manipulate the objects, but once some mastery is achieved the system may set the objects to only be viewed and not manipulated. Finally, once the student has fully mastered a given concept, the questions may be set to only be manipulated numerically so as to advance past reliance on the visual indicators.

Thus, in the preferred embodiment, the visualization engine 21 can include software and/or hardware modules including a manipulative mode, a visual mode, a numeric mode, and a visual-numeric mode, and the student can progress through the modes as they achieve mastery of a concept. The manipulative mode is a mode wherein the student can manipulate objects in an effort to answer a question. For example, the student may move gold coins into pirate chests when answering a math question. The visual mode is a mode in which the apparatus 5 manipulates the objects for the student so as to show the student how to answer a question and how to arrive at the answer. For example, the student can see and count objects and can watch as the computer illustrates how to answer a question by manipulating the objects, but cannot manipulate them onscreen. Numeric mode is a mode in which the student sees only a math problem and the numbers. Thus, there are no other visual cues to assist the student. The visual-numeric mode is a mode in which the student enters the numerical steps taken, and the system manipulates the objects and displays what is happening to the objects as a result of the student's numerical steps. Preferably, the student can toggle between modes as necessary.

In one embodiment, the visualization engine 21 also includes a “show me” mode which illustrates steps taken to reach exemplary questions. The “show me” mode can be allowed or disallowed by the teacher, parent, or administrator as desired.

However, if student performance degrades on a concept, the visualization engine 21 allows the student to go back to a previous learning mode (e.g., visual mode, visual-numeric mode, or manipulative mode) to better learn the topic. The apparatus 5 can then advance the student to more advanced modes after the student demonstrates the requisite mastery of the topic.

Preferably, the testing station 20 also includes software and/or hardware modules including a test administrator 22 through which the student can complete the assignment online. Once the assignment is personalized, the student can complete the test via the test administrator 22. The testing station 20 also includes an answers and steps recorder 24 comprising a memory, which records the final answer and steps taken to reach the final answer for each question can then be recorded by the recorder 24. The answers and steps recorder 24 can also record the steps and answers of each attempt at answering each question before reaching the final answer.

Optionally, the testing station 20 can include an audio-visual recording and/or transmission device 23 operable to monitor the student during completion of an assignment. Preferably, the audio-visual recording and/or transmission device 23 can be built-in to the computer the student uses to access the assignment. Alternatively, an external audio-visual recording and/or transmission device 23 can be used when one is not built into the computer. The audio-visual recording and/or transmission device 23 can be used when the student is remotely completing an assignment to discourage cheating. Alternatively, the audio-visual recording and/or transmission device 23 can be used in a classroom setting to verify that a teacher is not improperly assisting in completion of an assignment in the case of standardized tests. In the preferred embodiment, the audio-visual recording and/or transmission device is a webcam. Moreover, in the preferred embodiment, the apparatus 5 can include multiple audio-visual devices, for example one at each computer of the network.

Once the assignment is completed and saved by the answers and steps recorder 24, the completed assignment can be transmitted over a network to the grading station 30 of the apparatus 5.

Preferably, once all steps and answers have been recorded the grading station 30 automatically grades the assignment. In the preferred embodiment, the grading station 30 includes software and/or hardware modules including a steps evaluator 32 for evaluating the steps taken to reach each answer. Preferably, the grading station 30 can detect mistakes made by the student, not just in terms of the final answer, but also in steps taken to reach the answer thereby allowing the apparatus 5 to pinpoint conceptual errors in the student's understanding of the subject matter. Thus, the apparatus 5 allows teachers, parents and administrators to determine not just mastery of a topic or subtopic, but also where conceptual errors are occurring within the topics and subtopics. For example, the apparatus 5, by recording the steps taken to complete a long division problem and grading each step as described below, can pinpoint where errors are occurring, such as when dividing hundreds, converting hundreds to tens, dividing tens, converting tens to ones, dividing ones, etc., and thus can identify conceptual errors. This level of recording and grading can be achieved for each question of each assignment, for the assignment as a whole and across multiple assignments that the student has completed over time.

In one embodiment, the grading station 30 runs an algorithm for grading the steps and identifying concepts missed. The algorithm can include comparing a first step from a student to a correct first step from answer associated with problem. Preferably, the correct steps and answers are stored in an answers database 38 within the grading station 30 (shown in FIG. 1). If the step is correct, the step is graded as correct and the grading steps evaluator 32 proceeds to next step. Alternatively, if the first step is incorrect, the step is graded as incorrect and the steps evaluator 32 can proceed to next step. In another embodiment, if the first step is incorrect, the step is graded as incorrect and the steps evaluator 32 proceeds to the next question. Once each step within a first question is graded, the steps evaluator 32 proceeds to the next question until all steps of each questions have been graded. When marking correct or incorrect, the steps evaluator 32 can also mark the concept associated with that step as correct or incorrect based on a comparison to the correct answers and steps as saved in the answers database 38.

In another embodiment, an algorithm for grading the steps and identifying concepts missed includes comparing a first milestone from a student's answer to a correct milestone from answer associated with problem, which can be saved in the answers database 38. For example, in a long division problem of a three-digit number, the first milestone may be when all of the hundreds are distributed out to each of the containers to the full extent possible. If correct, the step is marked correct, and the steps evaluator 32 proceeds to next milestone. If incorrect, the step is marked as incorrect, and the steps evaluator 32 proceeds to next milestone. In another embodiment, if the first milestone is incorrect, the step is graded as incorrect and the steps evaluator 32 can proceed to the next question. Once the steps evaluator 32 reaches the end of a question, the steps evaluator proceeds to the next question. Once the steps evaluator 32 evaluates each step of each question, the steps evaluator 32 stops or continues to the next assignment. Preferably, when marking milestones correct or incorrect, the steps evaluator 32 can also mark the concept associated with that step as correct or incorrect.

Moreover, in a preferred embodiment, the apparatus 5 is designed to play back the exact actions and steps that the student took for that problem, display or play back just the step or milestones where the student made the first mistake, or it can play back or display all mistakes.

In one embodiment, the steps evaluator 32 may evaluate the steps in real time as the student performs and submits the steps. Thus, the steps evaluator 32 can be instructed to flag incorrect steps for further review while the student is completing the assignment in the testing station or on the spot before proceeding to the next step, in an immediate subsequent attempt or later (e.g., an assisted tutorial mode).

Preferably, the grading station 30 includes software and/or hardware modules including an answer grader 34 which provides a grade based on the final answers given. Preferably, the grading station 30 includes a missed concepts identifier 36, which reviews the steps and answers and pinpoints where conceptual errors occurred, if any, during completion of each question of the assignment. Thus, the grading station 30 grades the final answer along with steps leading to the answer, and points may be given for the steps as well as the final answer. For example, the grading station 30 can grade the steps of a long division problem along with the final answer and assign points for each correct step. Moreover, the grading station 30 can be instructed to grade each answer and steps taken in each attempt to answer the questions.

In the preferred embodiment, the apparatus 5 also includes an assignment reporting station 40 operable to provide a detailed report regarding the results of one or more assignments. Preferably, the assignment reporting station 40 generates an assignment report 44 identifying the questions missed, the number of attempts required to answer the questions correctly, and the steps taken and missed to reach the answer given to each question, and/or the concepts missed by the student. The report 44 can also include the time taken to complete the assignment and each question of the assignment, the number of questions that are correct or incorrect, and/or the time required to complete each step of each question. Preferably, the assignment report 44 also allows the teacher to view the questions missed and/or the steps, milestones and/or concepts missed. Moreover, the assignment report can show the progress of a group of students and compares the progress of the students within the group and across classes, teachers, schools, clusters of schools, school districts, states, nationwide, and internationally, if desired.

Also preferably, the assignment report 44 generated by the assignment reporting station 40 can create a grade book view for the teacher, which lists the progress of each student in a class and the grade for each assignment, overall grade and/or student progress towards completion of assignments and/or mastery of subject matter. Moreover, the grade book view can also detail late assignments, absences, list the concepts missed per student or groups of students, and can also group students by concepts missed so that the teacher can teach specific concepts to each group. The grade book also allows for the entry of information manually by the teacher in cases where assignments are completed outside of the apparatus.

For example, the assignment report 44 for parents, teachers and/or administrators, including schools and/or school districts, can include overall class progress versus others in the same school and/or same grade level using the same assignment plan, overall class progress on key topics against various standards (e.g., core standards, state standards, state tests, national standards, National Assessment of Educational Progress (NAEP)), class progress with students grouped by cohort for particular topic and showing upcoming assignments, progress on key topics by student for all students in a class as compared to progress of the class, an entire school, and/or District averages, progress on key topics by student, for selected student(s) showing problems missed and concepts missed within and across problems (e.g., converting hundreds to tens), progress on each of the key topic areas (e.g., long division) for all students in a selected cohort group(s), also showing Grade, School, and District averages, progress on each of the key sub-topic areas (e.g., dividing four-digit numbers by 7) for all students in a selected cohort group(s), and/or projected progress for selected student(s) against various standards (e.g., core standards, state standards, state tests, national standards, National Assessment of Educational Progress (NAEP)). Moreover, the reports can be generated to compare student performance across one or multiple years.

For example, the report 44 can report on proficiency and weaknesses of the student based on topic, subtopic and specific concepts (e.g, in addition to long division (topic), also long division of a three-digit number (subtopic) and dividing hundreds, converting hundreds to tens, dividing tens, converting tens to one, dividing ones, etc. (concept)) both for specific questions and assignments and overall for each student and/or group.

Additionally, the report 44 can be instructed to include an indication of what mode was used to complete each assignment and for specific questions within an assignment. Thus, the report would include notations where manipulative mode, visual mode, numeric mode or “show me” mode is used. Moreover, the visualization engine 21 can be set to test mode to prevent use of show me mode and/or other modes when desired.

In the preferred embodiment, the assignment reporting station 40 can also include a progress tracker 48 operable to track the progress of individual students and groups of students by verifying that issued assignments have been completed and by reviewing graded assignments. The progress tracker 48 can also maintain a list of assignments completed and/or mastered by each student and update the progress of each student to reflect completion of assignments and/or mastery of subject matter based upon grades, mode used and other such information. Teachers can then view the progress of their class and compare the progress to classes in the same and/or other schools. If the teacher finds a class progressing at a faster rate, the teacher can then access the assignment library to view assignments being given by other teachers, visit those teachers to observe them or can use the audio-visual device incorporated herein to remotely observe the teacher instructing students or view and/or listen to recordings of that teacher teaching those particular topics, subtopics, and/or concepts when the assignment tests.

Also preferably, the assignment reporting station 40 comprises software and/or hardware which can generate alerts 46. The alerts 46 can be generated by the assignment reporting station 40 when certain events occur. For example, alerts 46 can be generated when student performance falls below or exceeds predetermined thresholds on topics and/or the underlying concepts of the topic. Such thresholds can be set by teachers, parents, and/or administrators. The alerts 46 can be included in the report 44 or can be sent as a separate report to students, teachers, parents and/or administrators by email, text message, fax, phone or mail. Alerts 46 can also be generated in response to assignment completion, due dates and/or overdue assignments. The alerts 46 can be provided, along with the report 44, to the curriculum and assignment adjustment station 60, and can be used to determine necessary changes to the curriculum and/or assignments.

Preferably, the apparatus 5 can also include the FPP station 50 operable to provide predictive data regarding how individual students, groups of students including students instructed by certain teachers and/or within certain schools, districts and/or demographic groups may perform on future assignments including standardized tests. In the preferred embodiment, the FPP station 50 generates a report which can predict the gains that various assignments may produce on a given group of students relative to their individual starting level and progress in the system. Preferably, the report can be refined over time as students complete additional assignments. The report can further predict the expected gains based on the actual historical gains of other similar groups of students using the same curriculum, including curricula tailored to an individual student, group of students, and/or an entire school to produce the maximum gains for that population. Preferably, the FPP station 50 can generate a report predicting the percentage of students using the method and apparatus described herein that can be expected to pass standardized tests covering subject matter similar to the assignments.

Also preferably, the apparatus 5 can further include a standards database 52 which can store district, state and national standards, which can be compared to the student and/or group performance to determine progress of the student and/or group in relation to the standards. The FPP station 50 and/or assignment generating station 10 can be in communication with the standards database 52 via a network. Alternatively, the FPP station 50, the assignment generating station 10 and/or the standards database 52 can be located on a common server and/or a common computer. Thus, the FPP station 50 can retrieve standards from the standards database 52 and compare student performance on a completed assignment to the standards to determine how a student is progressing as compared to state and/or national standards and can then predict how a student will perform on future assignments based on this comparison.

In a particular embodiment, the apparatus also includes the curriculum and assignment adjustment station 60 operable to adjust the curriculum and/or assignments used to instruct and/or test the student. Preferably, the assignment reporting station 40, the assignment generating station 10 and/or the FPP station 50 can provide reports to the curriculum and assignment adjustment station 60. Also preferably, the curriculum and assignment adjustment station 60 provides feedback to the assignment generating station 10, and can adjust and/or recommend future assignments generated by the assignment generating station 10 based on the planned assignments 16 and the progress of individual students and/or groups of students as indicated in the reports generated by the reporting station 40 and the FPP station 50. Thus, the curriculum and assignment adjustment station 40 can command and/or recommend adjustments 62. The teacher, administrator, parent and/or student can accept the adjustments 68.

In one embodiment, the curriculum and assignment adjustment station 60 can suggest lesson plans and resources for teachers on how to teach the topic or concept both online and offline. The curriculum and assignment adjustment station 60 can also provide links to audio-visual lessons to teach the concepts and topics identified as weak areas.

As shown in FIG. 2, an exemplary system 100 for teaching subject matter includes at least two computers, 105, 130 and a server 160. The server can include one or more computers or a server farm, in any location. The computers 105, 130 are in communication with the server 160 via a network, such as a LAN or the internet or other suitable connection. Optionally, the system 100 can include additional computers 110, 120, which are also in communication with the server 160 via the network or other suitable connection. As shown, the system 100 can include at least one teacher computer 105, at least one administrator computer 120, at least one parent computer 110, and at least one student computer 130. Preferably, the teacher computer 105, administrator computer 120, parent computer 110 and the student computer 130 are in communication with a server 160.

In an embodiment, each of the computers 105, 110, 120, 130 can include a bus, a processor, a memory, a read only memory, a storage device, an input device, an output device and a communication interface. The computers 105, 110, 120, 130 can include software stored in the memory and/or hardware components for implementing the features of the apparatus and method described herein.

Preferably, the server 160 stores at least one assignment 170, at least one completed assignment 180, at least one assignment report 190 and/or at least one future performance prediction report (FPPR) 200. Moreover, the server may serve as the testing station, grading station, assignment reporting station and/or future performance prediction station.

In the preferred embodiment, the teacher computer 105 can be used to upload an assignment 170 to the server 160, and the student computer 130 can be used by one or more students to access and complete the assignment 170. The completed assignment can then be saved on the server 160 and graded electronically as described above. Preferably, the teacher computer 105, the parent computer 110, and/or the administrator computer 120 can be used to access the assignment report 190 and/or the FPPR 200, which can also be saved on the server.

In a particular embodiment, the assignment can include one or more questions. In one embodiment, the teacher computer 105 can be used to upload the assignment 170 which can include a set of questions. In another embodiment, the teacher computer 105 can be used to upload a plurality of questions and the assignment generating station 10, as shown in FIG. 1, can generate an assignment including a subset of questions based on previous assignment reports, FPPR's and the recommendations of the curriculum and assignment adjustment station 60.

Preferably, the student can log into the server 160 via a student computer 130 and access the assignment 170. Once the assignment 170 is completed, the answers to the questions of the assignment 170 along with the steps taken to reach the answers are saved as the completed assignment 180.

Preferably, the completed assignment 180 is then graded electronically and the graded assignment is used to generate the assignment report 190 and/or the FPPR 200. Preferably, the completed assignment 180 includes the final answer given to each question of the assignment 170 along with steps taken to reach the final answer. The completed assignment 180 can also include attempted answers, answers given prior to providing the final answer, and steps taken to reach the attempted answer.

Once the assignment is completed 180, the assignment report 190 and the FPPR 200 can be generated. As described above, the assignment report 190 can provide data regarding conceptual problems based not only on incorrect final answers, but also on incorrect steps taken to reach both correct and/or incorrect answers. The assignment report 190 can also include information regarding time spent per question, time spent per assignment, date and time the assignment was completed, and other such information as described above.

In the preferred embodiment, the completed assignment 180 can also be used to generate the future performance prediction report 200. Preferably, the FPPR 200 can include a predictive analysis regarding future student performance. For example, the FPPR 200 can include a prediction of how the student might score on future assignments based on the score of the completed assignment 180 and/or how the student will perform on standardized tests. Such predictions regarding standardized tests can be made by comparing the students' performance to the standards database to compare student performance to state and/or national standards,

Once the assignment report 190 and the FPPR 200 are generated, a teacher can access the server to obtain the reports 190, 200. Parents can also access the assignment report 190 and the FPPR 200 via a parent computer 110 to determine performance of their children and to determine where additional tutoring may be most beneficial. In an embodiment, the parents may also create, save, edit and assign assignments based on the assignment report 190 and the FPPR 200. In another embodiment, the reports 190, 200 can be sent automatically to the student, teacher, parent, and/or administrator.

In the preferred embodiment, administrators can also access the assignment report 190 and the FPPR 200 via the administrator computer 120 to see how individual students, groups of students, an entire school and/or multiple schools are faring, what assignments have been issued by teachers, what assignments students have completed, how well they are performing on the assignments, and what concepts students are not understanding. The administrator can view reports based on topic and skill level for each student and/or groups of students. This information can be used to determine how individual students and/or group of students are expected to perform on standardized tests. Moreover, the administrator can view reports based on the teacher for the current or past years. Thus, this information can be used to determine if teachers need additional training to better teach students, or to recommend assignments, lesson plans, and teaching resources to enable the teacher to better address their students' learning needs.

Alternatively, the assignment generating station 10, testing station 20, grading station 30, assignment reporting station 40, future performance prediction station 50, curriculum and assignment adjustment station 60, and standards database 52 can be software and/or hardware modules located on the same computer or each can be located on different computers in communication via a network, such as a LAN or the internet. For example, an assignment can be generated by the assignment generating station 10 housed on one computer, which transmits the assignment over a network to a second computer which houses the testing station 20. A student can complete the test on the second computer housing the testing station 20, and the completed test can be sent to a third computer housing the grading station 20.

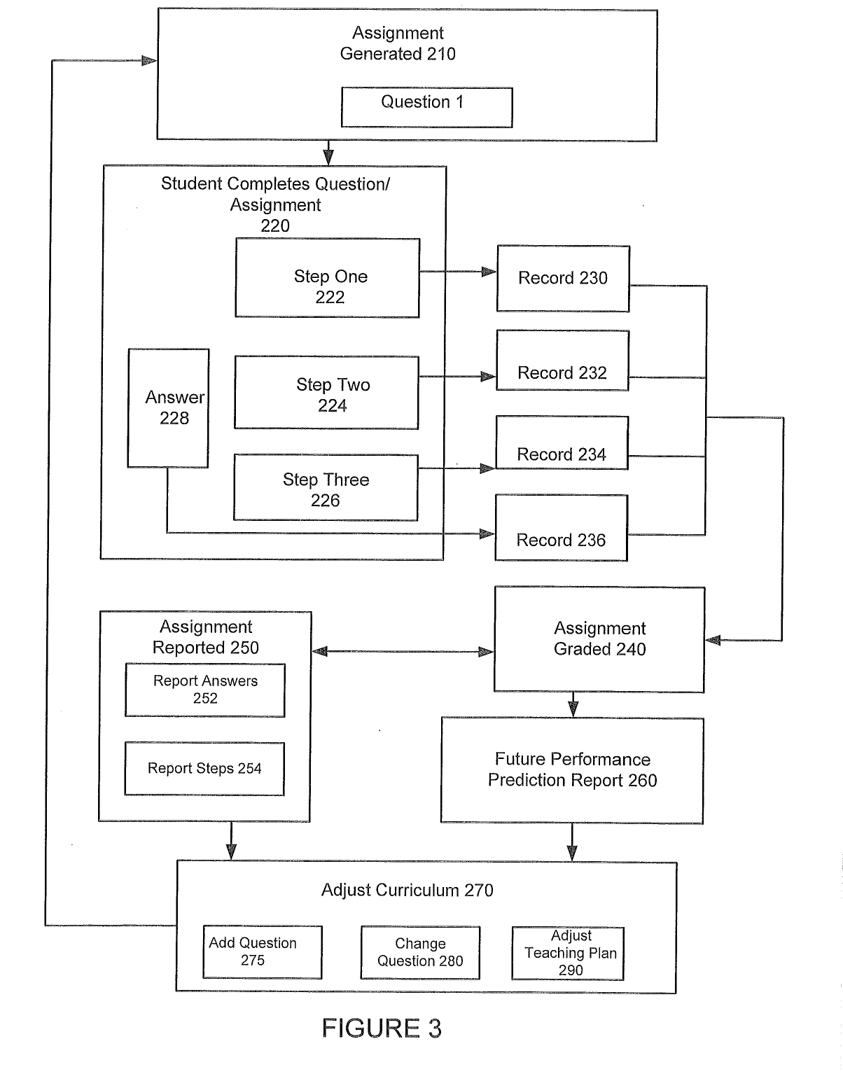

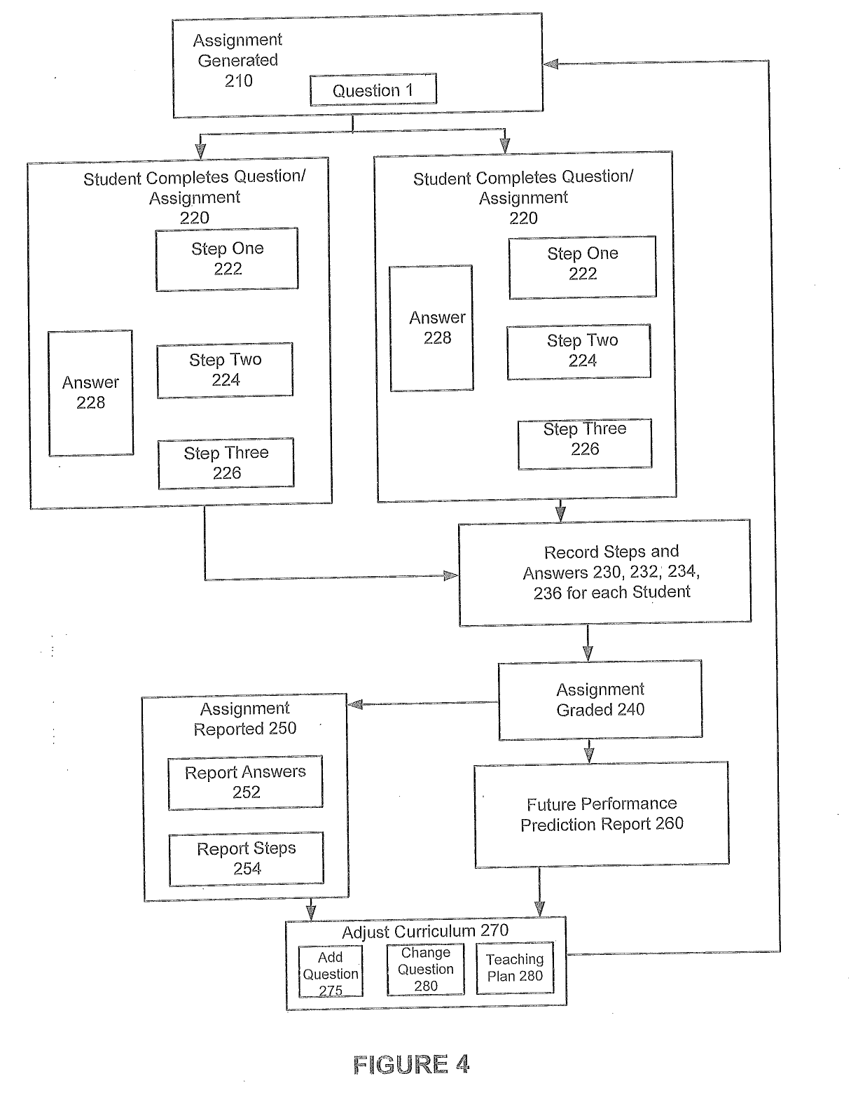

As shown in FIGS. 3 and 4, in a preferred embodiment, a method for teaching subject matter, in particular mathematics, includes generating 210 an assignment including one or more questions. Preferably, the assignment is provided to one or more students who complete 220 the assignment. In the preferred embodiment, the student must show one or more steps 222, 224, 226 taken to arrive at an answer along with the answer 228 to complete the assignment. Each of the steps and the final answer is then recorded 230, 232, 234, 236. Preferably, the completed assignment is then graded 240. As noted above in relation to FIG. 1, the apparatus 5 can include a visualization engine 21 operable to allow the student to complete the assignment in manipulative mode, visual mode, numeric mode and/or show me mode.

In the preferred embodiment, the graded assignment is then used to generate 250 the assignment report and to generate 260 the FPPR as described above. Preferably, the method of reporting the assignment includes reporting the grade obtained due to final answers 252 and/or the grade obtained based on the steps taken to reach the answers 254.

In the preferred embodiment, the reports can be used to adjust the curriculum 270. Adjustment of the curriculum can include adding questions 275 to the question database, changing 280 questions, adding and/or removing entire assignments, and/or altering 290 the teaching plan to focus on areas of poor student performance.

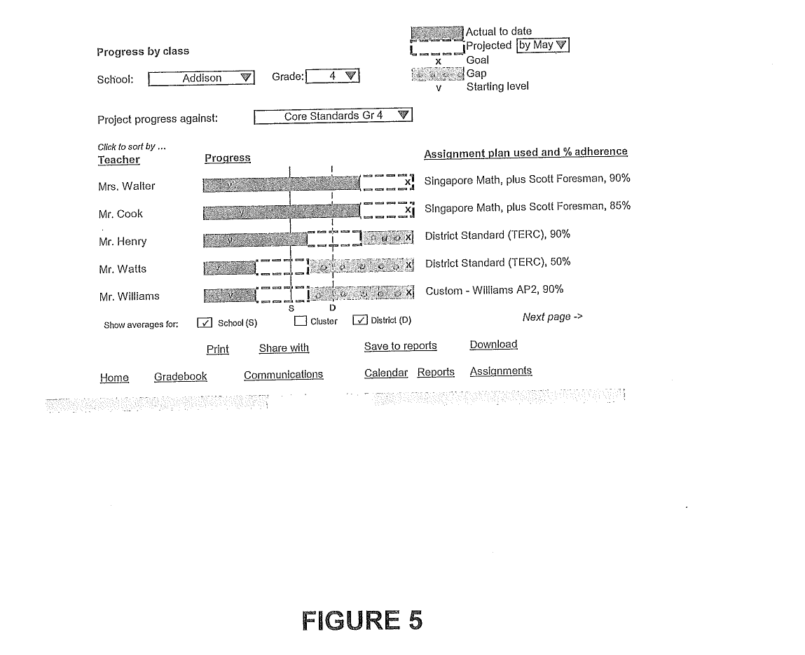

FIG. 5 shows an exemplary display of the assignment report showing progress of students, by teacher. As shown, the display can include drop-down boxes for selecting the report based on school, grade, standards to compare current progress against, and goal date. Such assignments reports can also be adapted to show the composition of the assignment plan and percent to which the plan has been adhered. The report can also be adapted to flag projected gaps in progress by set due dates.

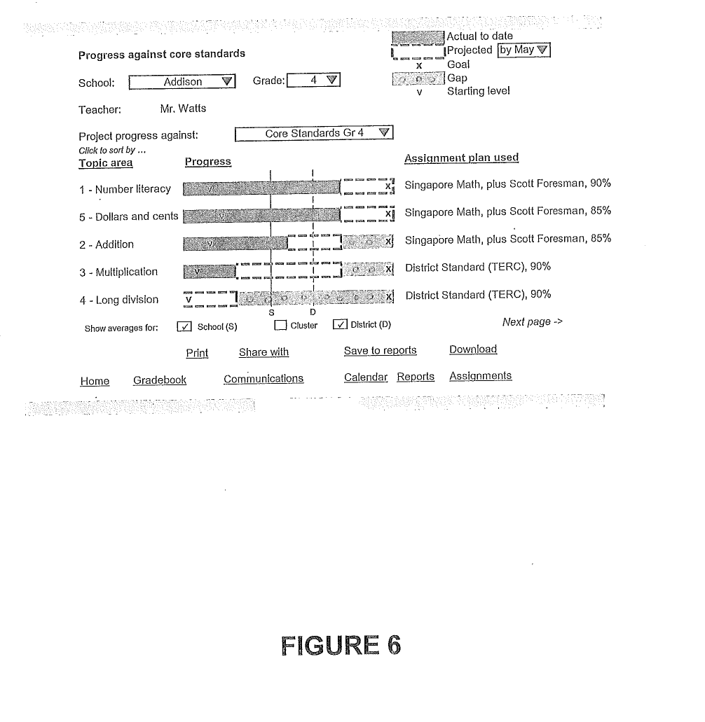

FIG. 6 shows an exemplary display of the assignment report showing progress of a group of students by topic as compared to core standards.

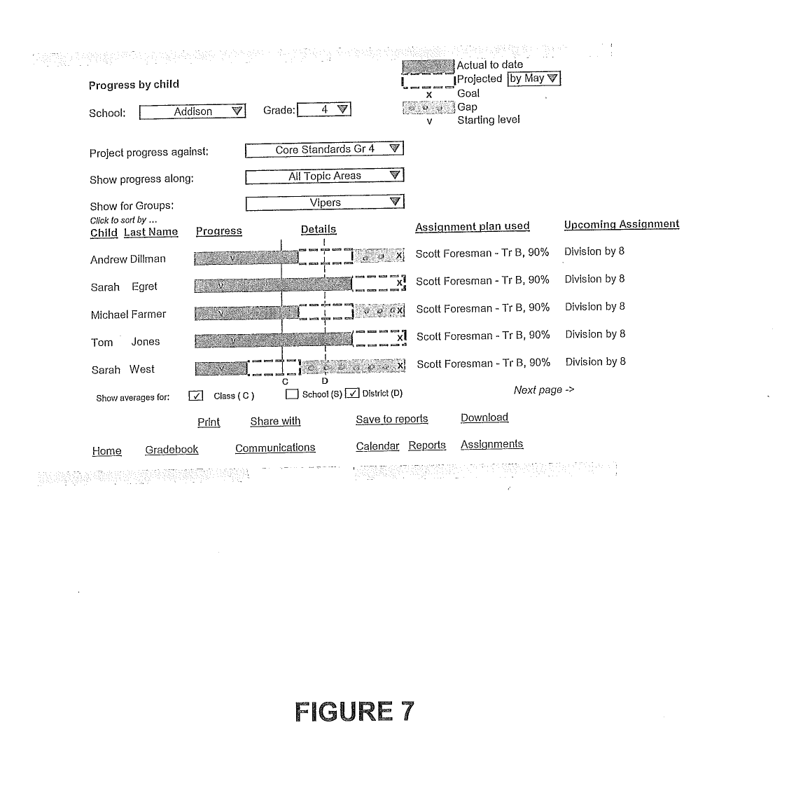

FIG. 7 shows an exemplary display of the assignment report showing progress of individual students.

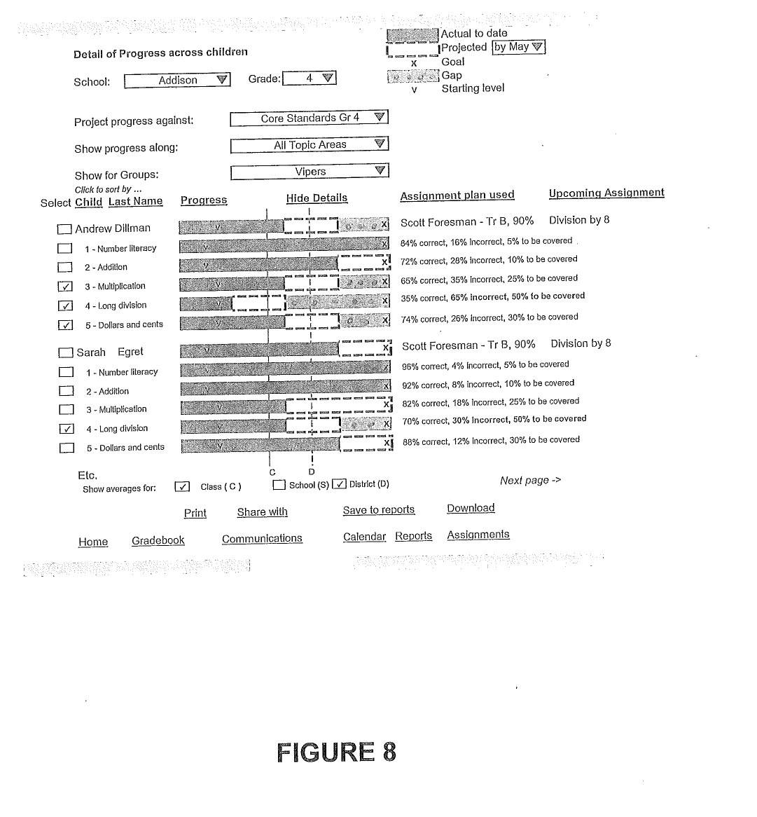

FIG. 8 is an exemplary display of the assignment report showing details of progress across students.

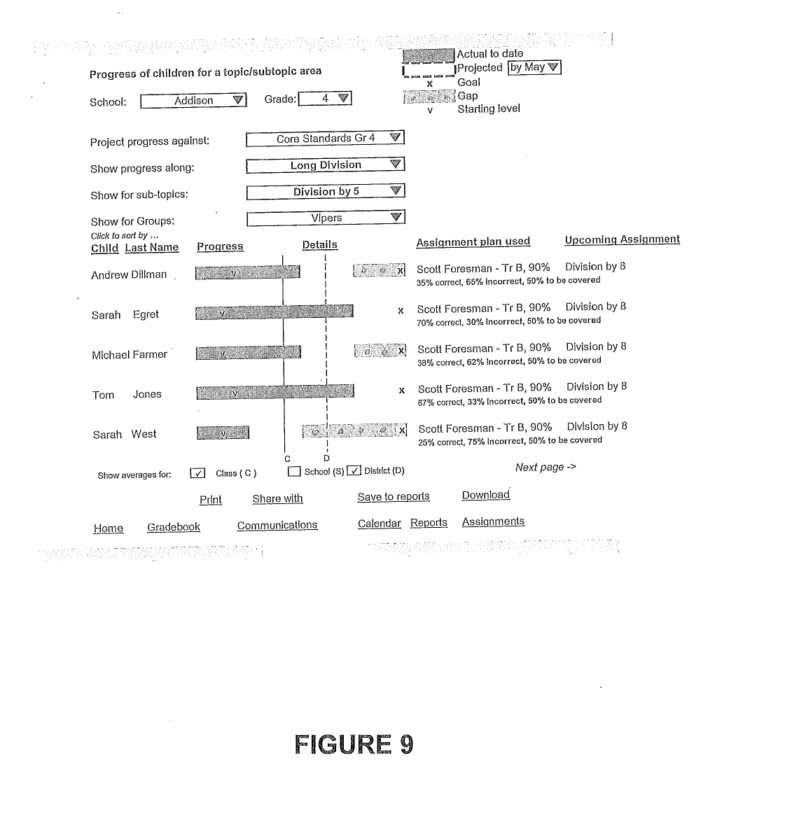

FIG. 9 is an exemplary display of the assignment report showing progress of students for a topic/subtopic area.

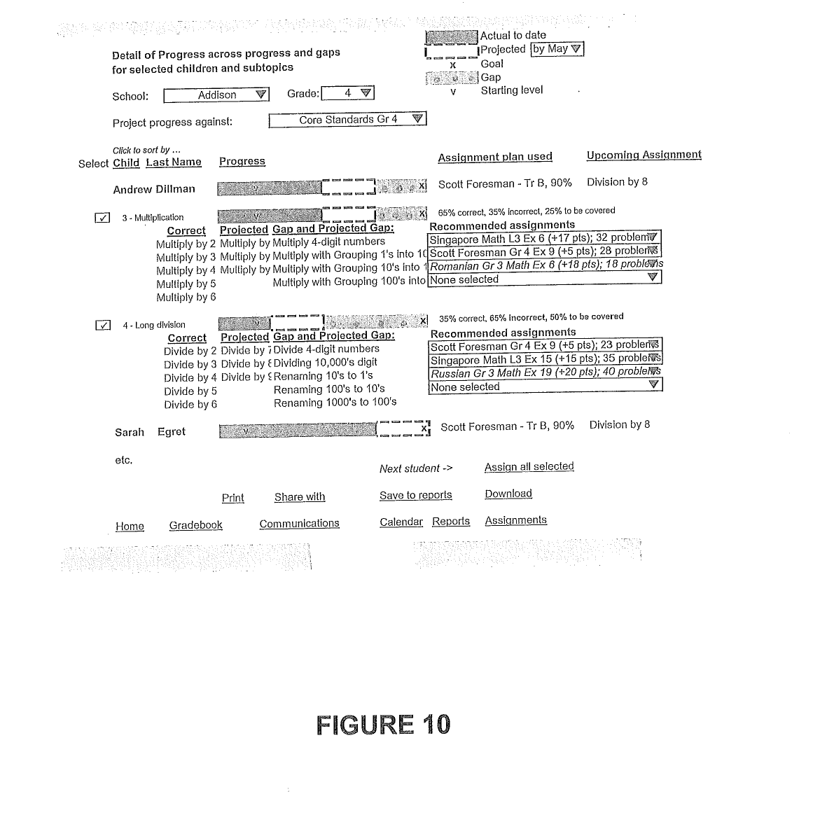

FIG. 10 is an exemplary display of the assignment report showing projected gaps for select students and subtopics.

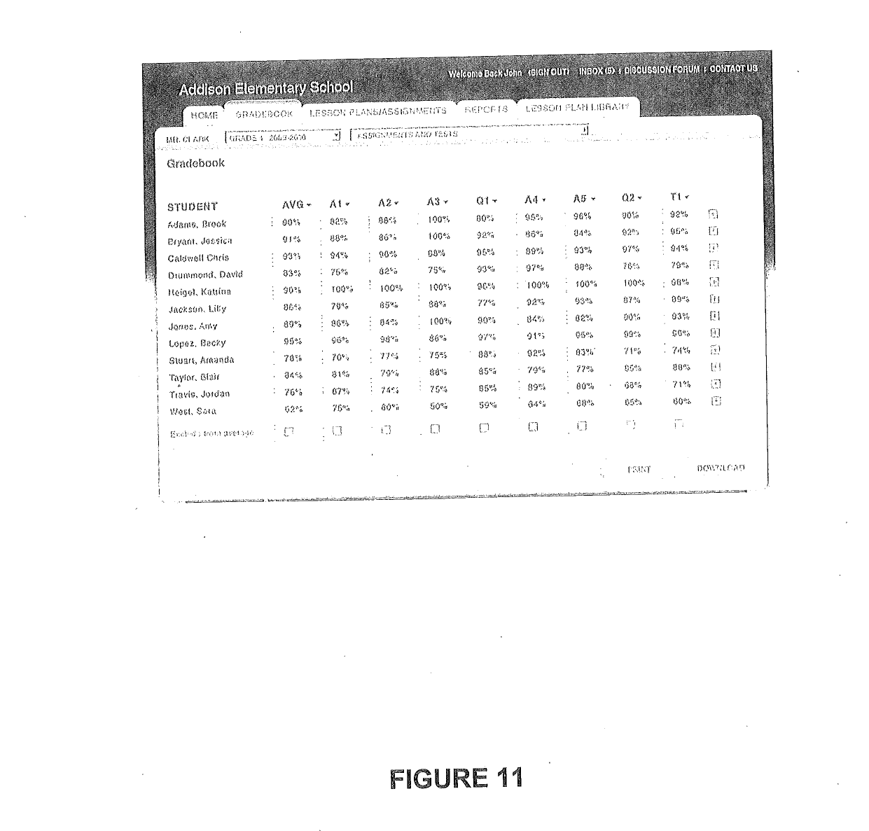

FIG. 11 is an exemplary display showing a grade book view of a group of students. The assignment reporting station can generate such a grade book view of a selected group of students for one or more assignments. The report can be generated by request of a teacher or the assignment reporting station 40 can be instructed to generate a grade book report upon receiving an alert notifying the station 40 that all members of the selected group have completed the assignment.

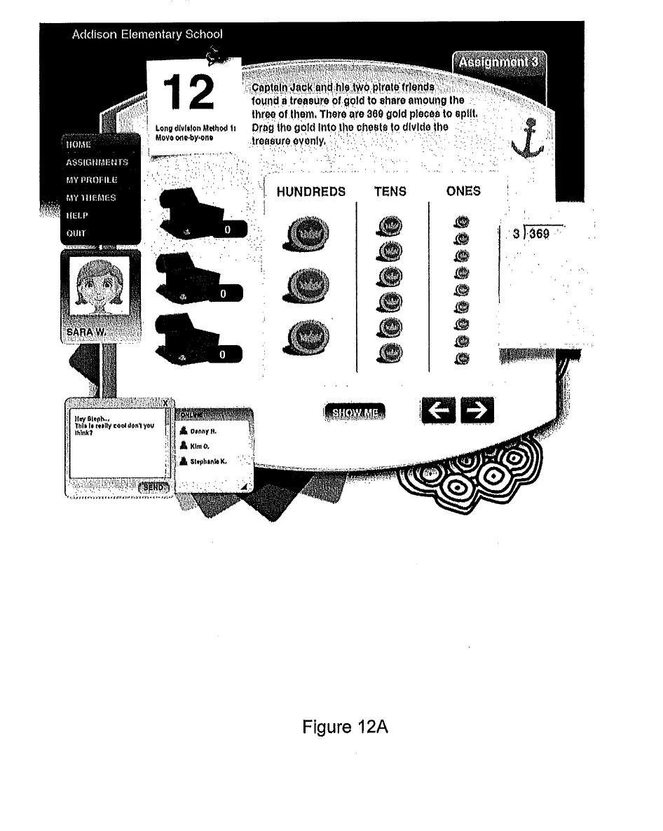

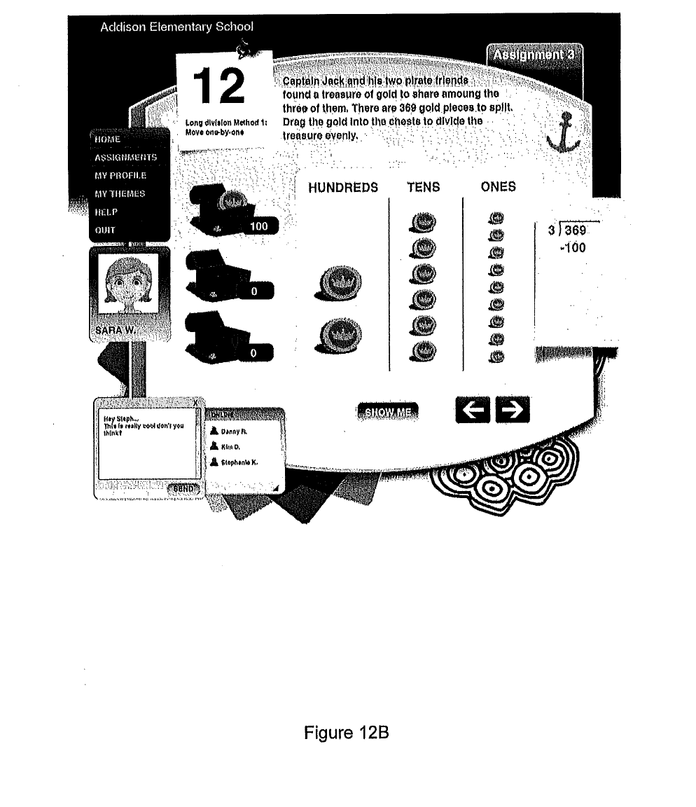

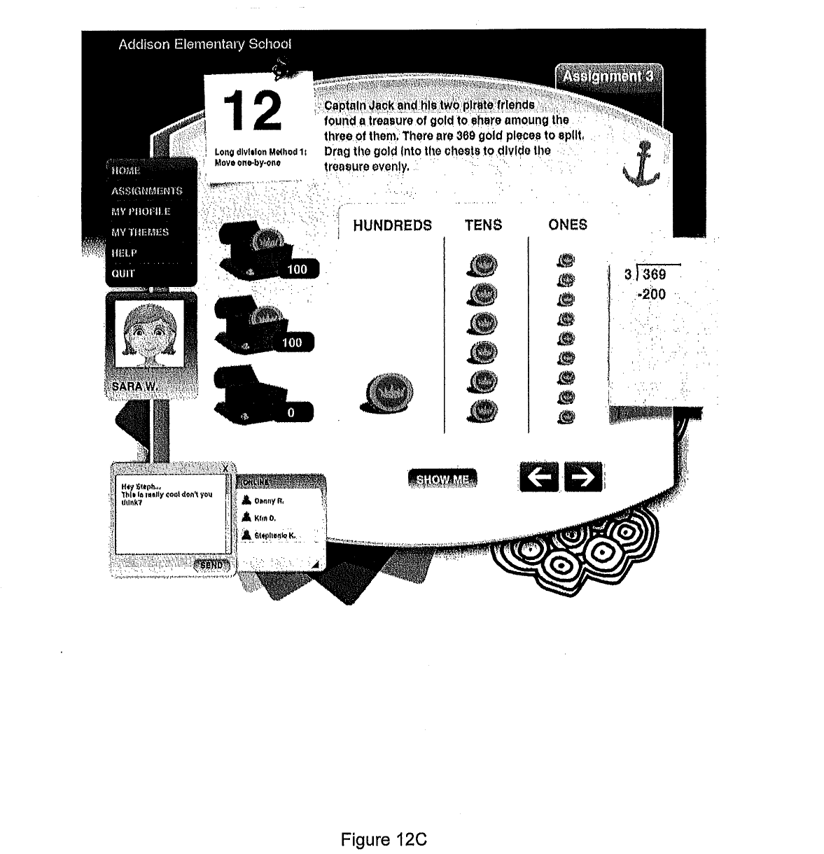

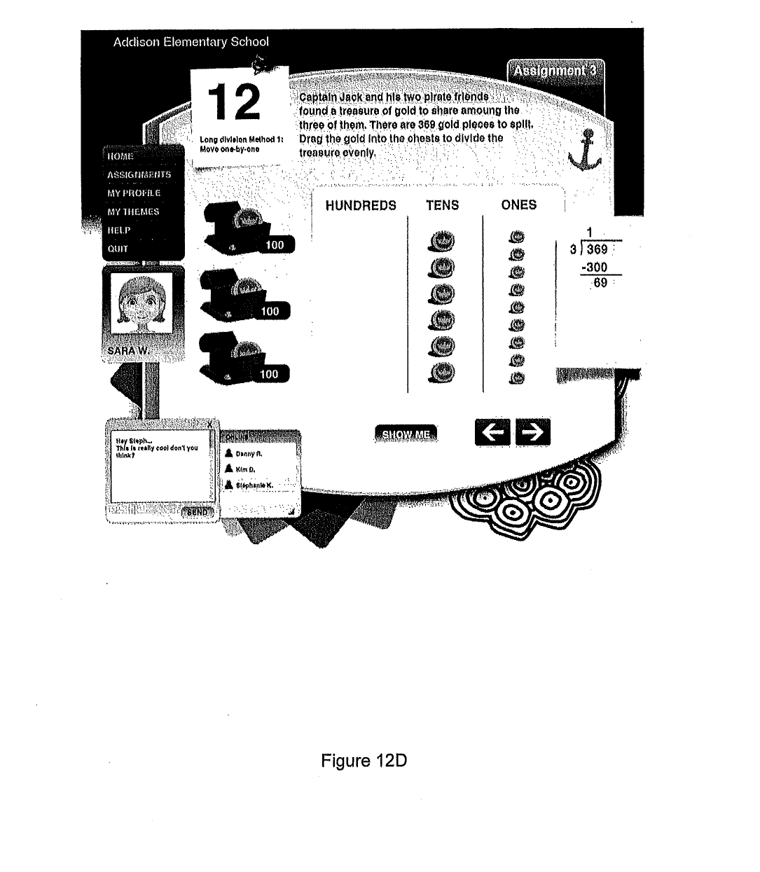

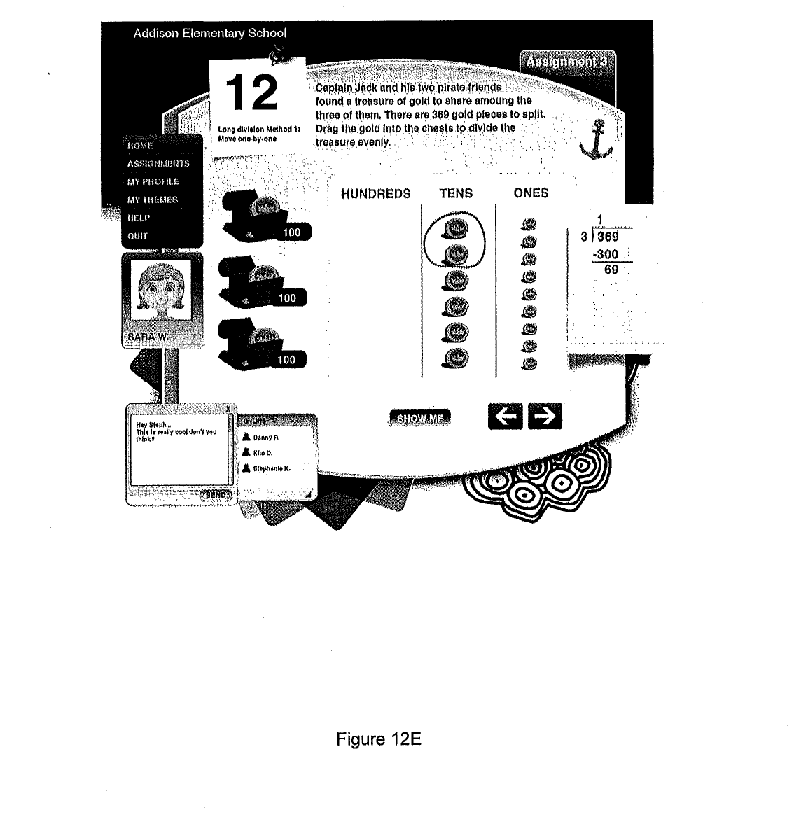

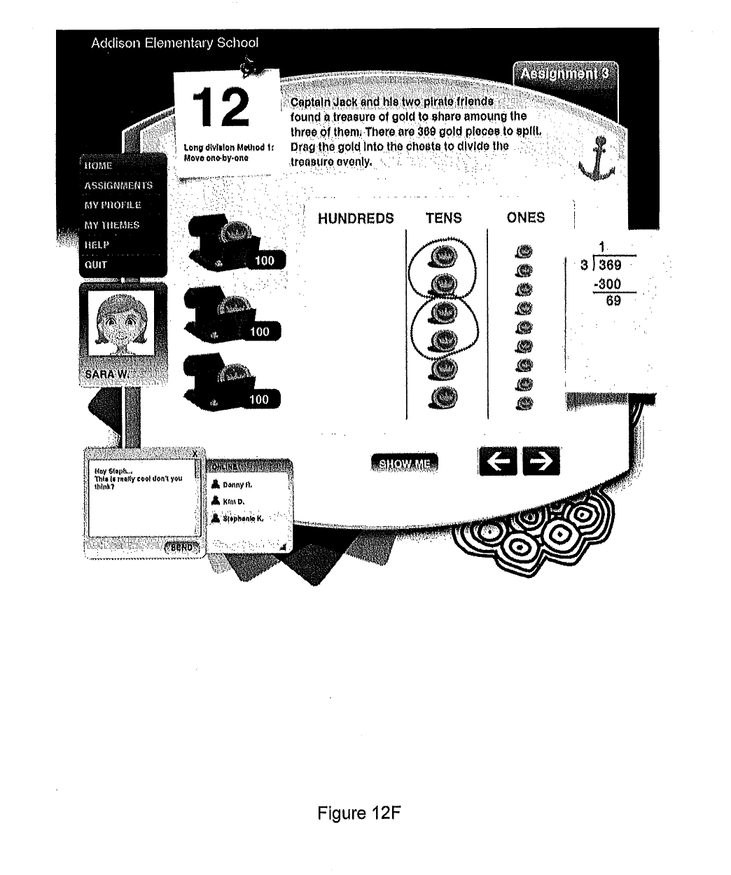

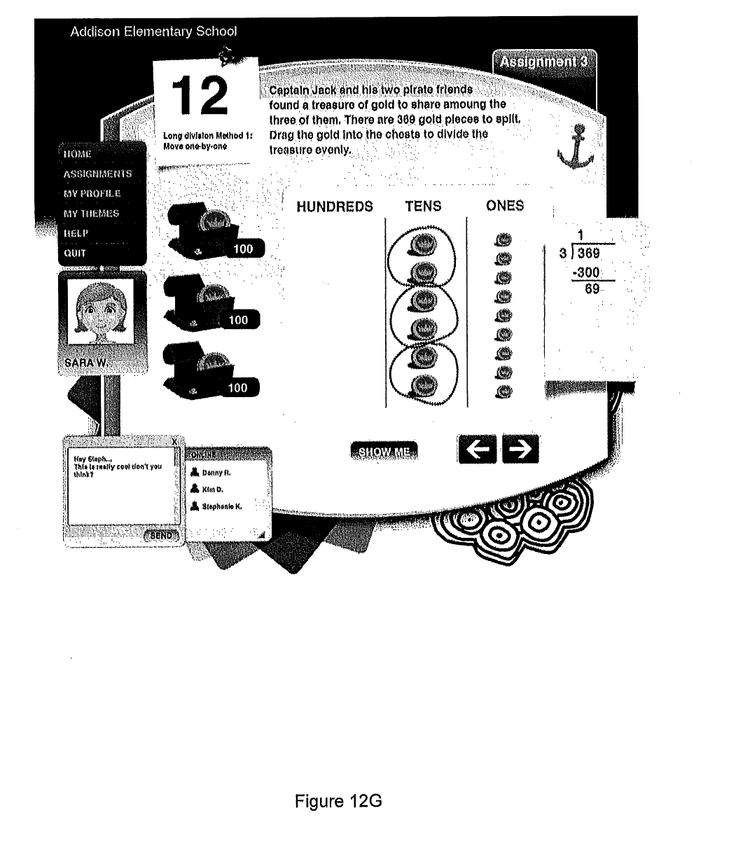

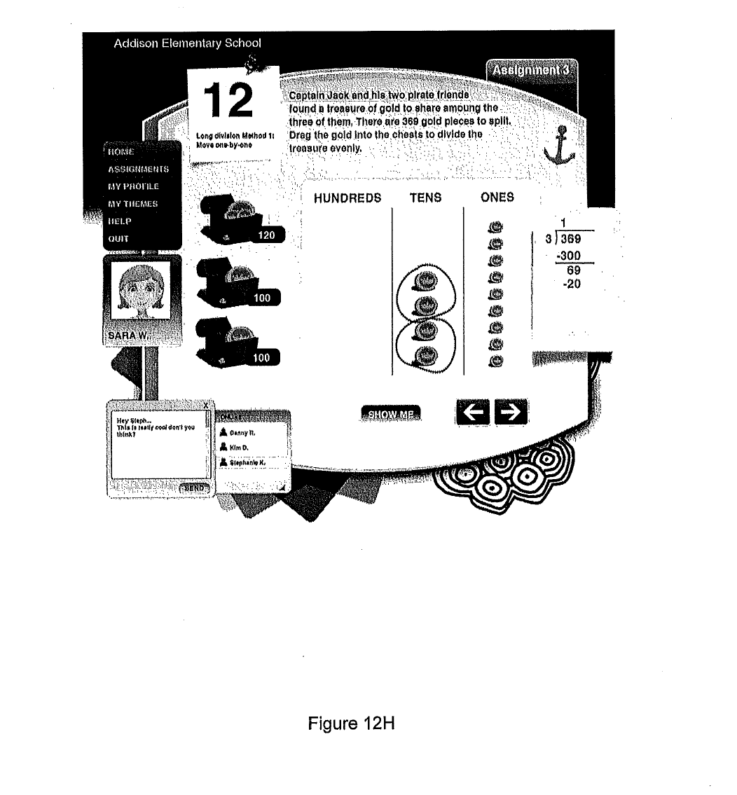

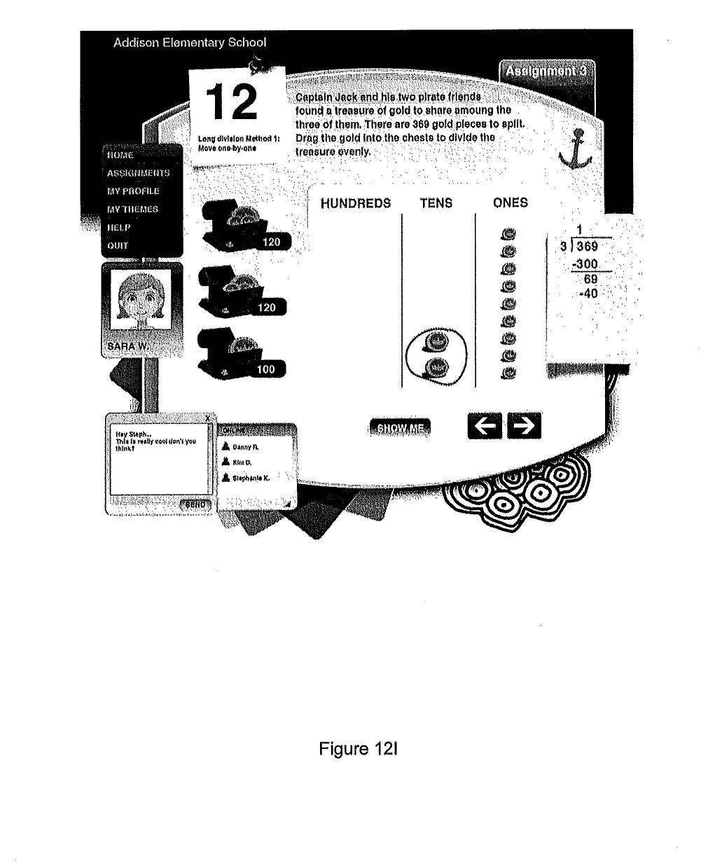

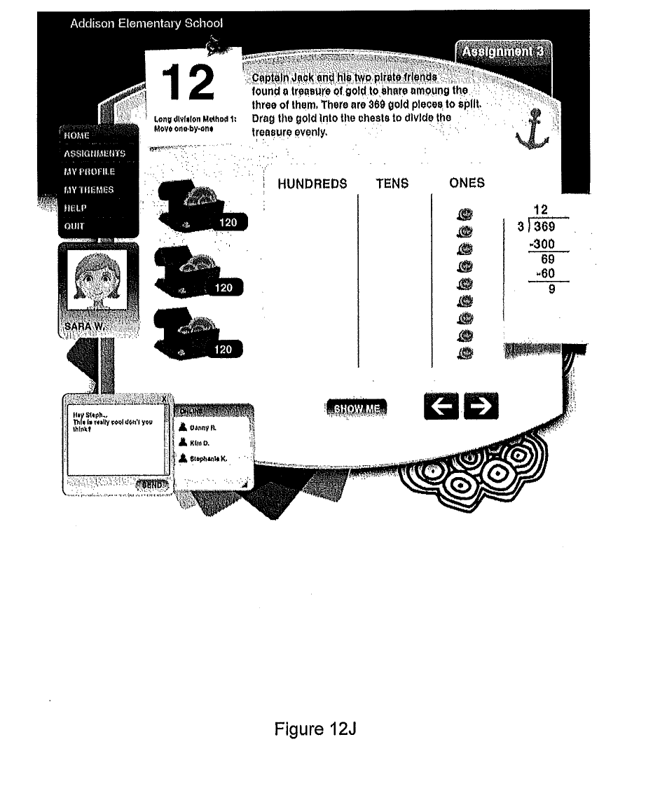

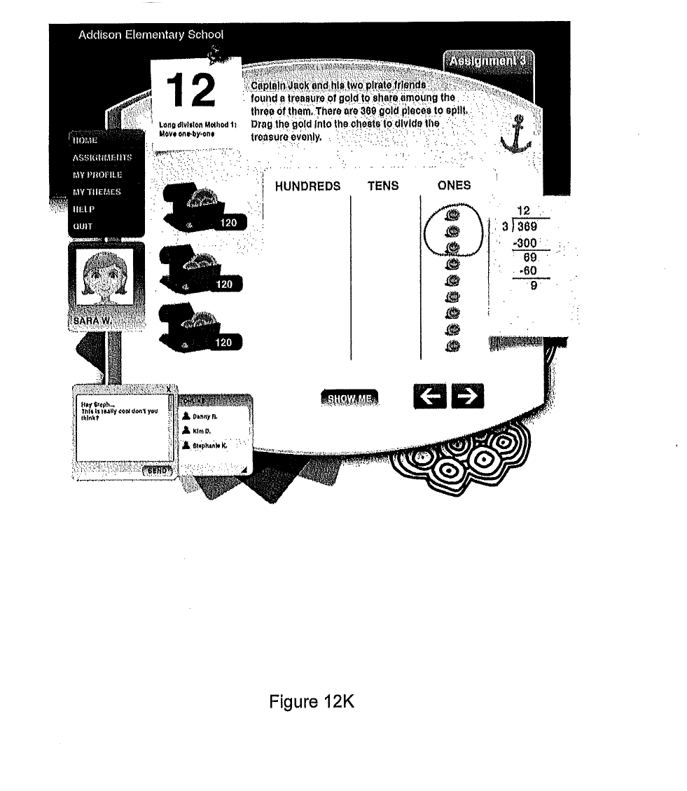

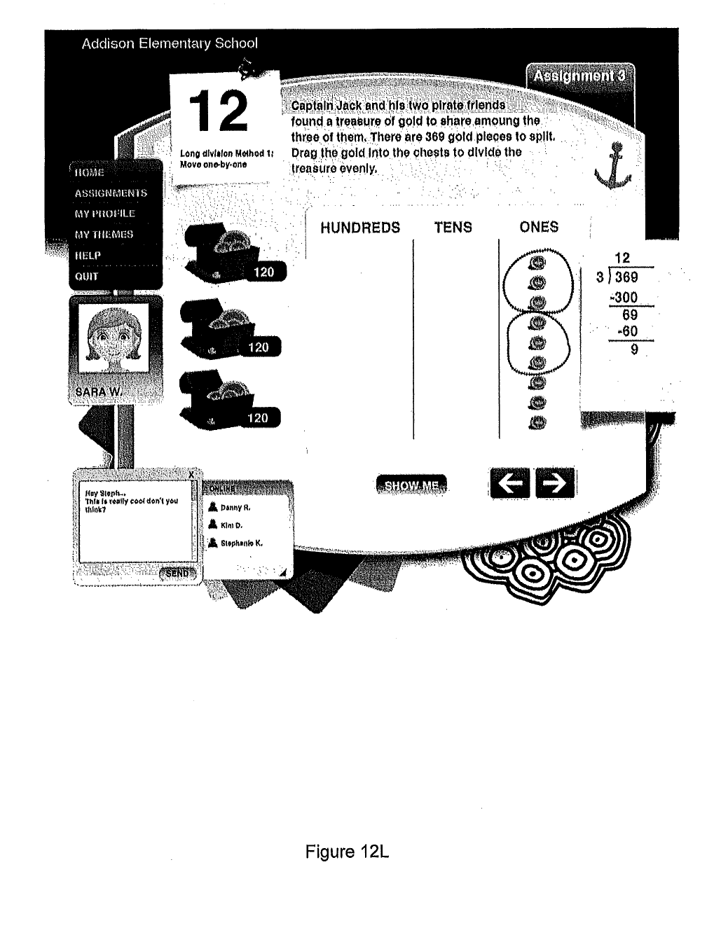

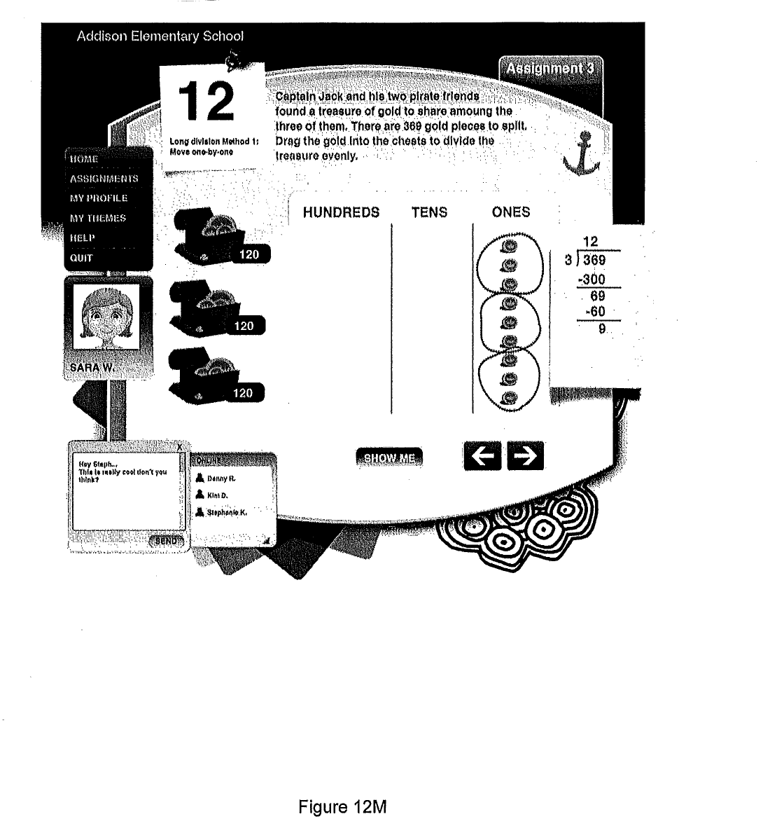

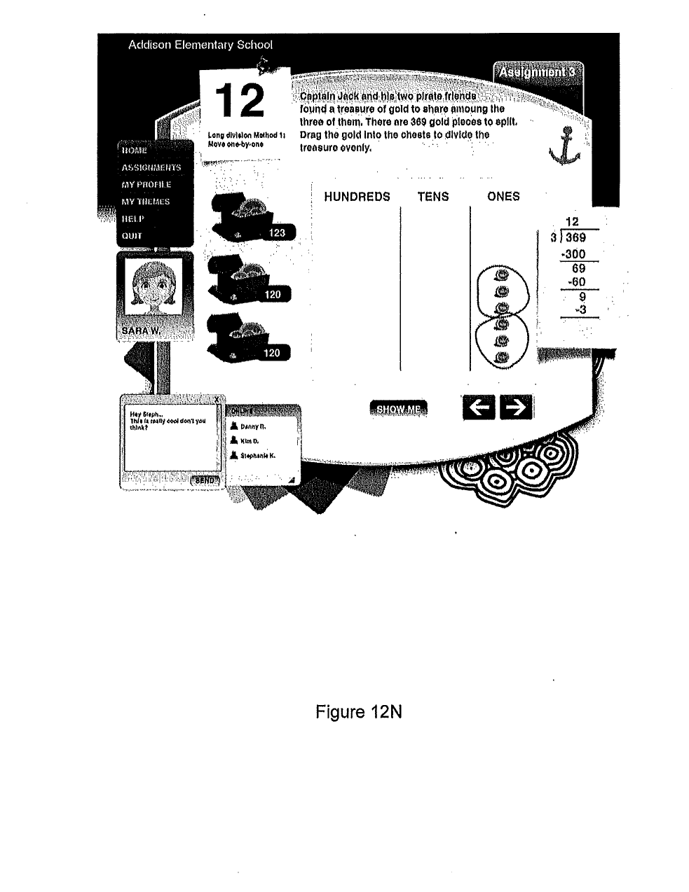

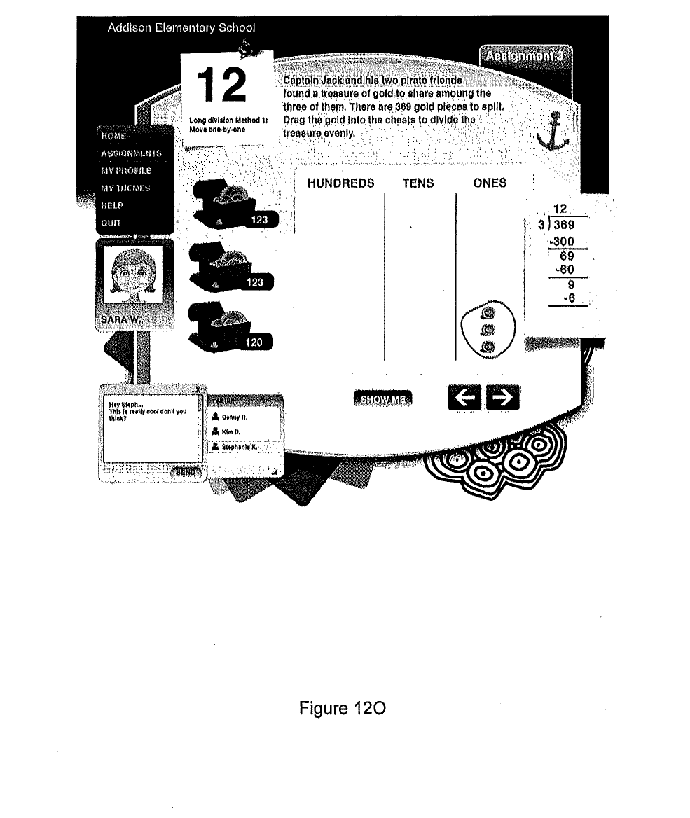

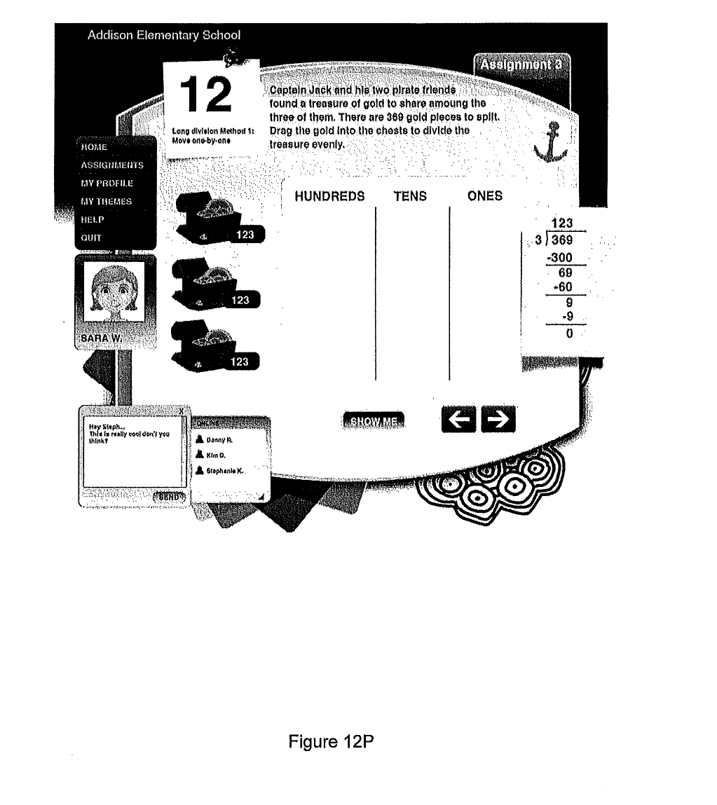

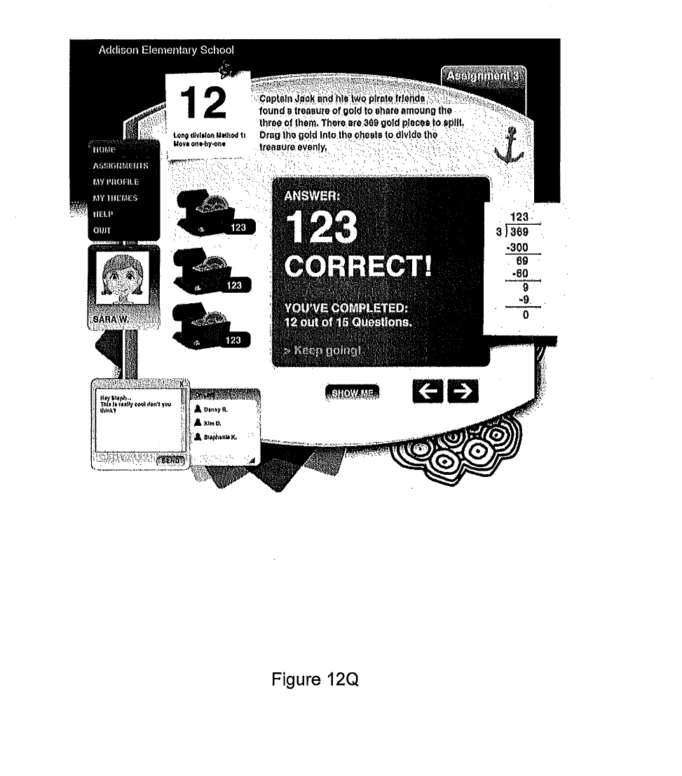

FIGS. 12A, 12B, 12C, 12D, 12E, 12F, 12G, 12H, 12I, 12J, 12K, 12L, 12M, 12N, 12O, 12P, and 12Q illustrate exemplary displays depicting a long division math problem as part of a pirate themed game via a testing station in manipulative mode. As shown, the steps taken to reach the answer are recorded as the steps are taken. Once the answer is reached, the answer is also recorded. As shown, the assignment includes a question, for example a long division question as shown in FIG. 12A. The student can show a first step to answer the question by dragging a gold coin having a value of 100 to a first treasure chest as shown in FIG. 12B, gold coin having a value of 100 to a second treasure chest as shown in FIG. 12C, and a gold coin having a value of 100 to a third treasure chest as shown in FIG. 12D. The student can then grab two gold coins, each having a value of 10, as shown in FIG. 12E, grab two more gold coins, each having a value of 10, as shown in FIG. 12F, and two more gold coins, each having a value of 10, as shown in FIG. 12G. The student can move the first two gold coins to a treasure chest as shown in FIG. 12H, move the second two gold coins to a second treasure chest as shown in FIG. 12I, and move the third set of gold coins to a third treasure chest as shown in 12J resulting in the recordation of a second step of dividing tens. Finally, the student can grab a first set of three gold coins each having a value of 1, as shown in FIG. 12K, a second set of three gold coins each having a value of 1, as shown in FIG. 12L, and a third set of three gold coins each having a value of 1, as shown in FIG. 12M. The first set can be moved to the first treasure chest as shown in FIG. 12N, the second set can be moved to the second treasure chest as shown in FIG. 12O, and the third set can be moved to the third treasure chest as shown in FIG. 12P so that a third step of dividing by ones is recorded. As described above, the grading station can be in communication with the testing station via a network so that the answers and steps are immediately recorded and the results of each answer can be provided to the student as shown in FIG. 12Q in real time.

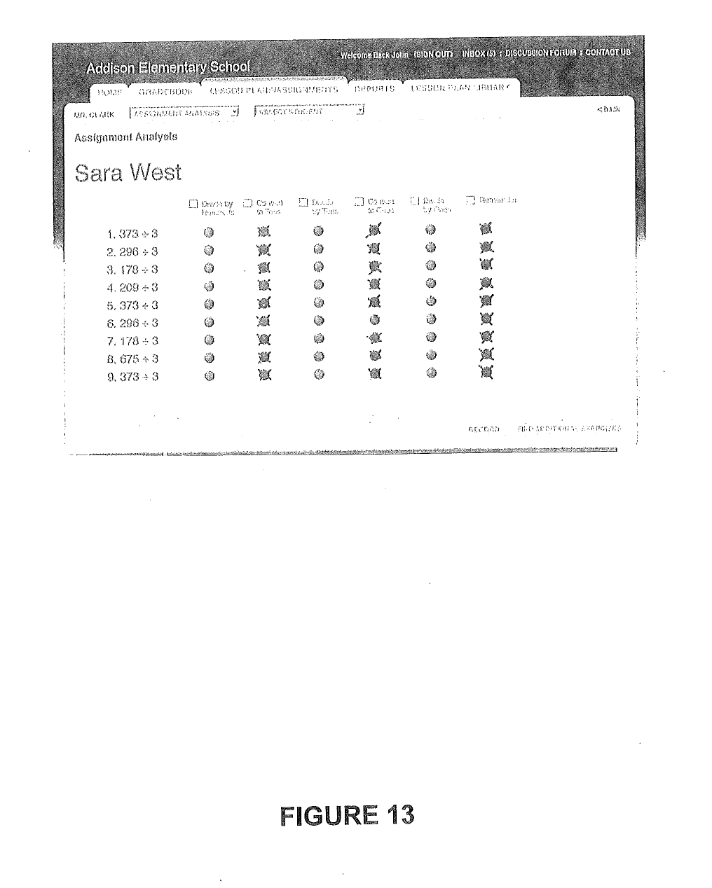

FIG. 13 is an exemplary display of a report showing grades based on steps taken to reach an answer as described herein. As shown, the report indicates which steps were answered correctly or incorrectly.

All numbers expressing quantities or parameters used in the specification are to be understood as additionally being modified in all instances by the term “about.” Notwithstanding the numerical ranges and parameters set forth, the broad scope of the subject matter presented herein are approximations, the numerical values set forth are indicated as precisely as possible. For example, any numerical value may inherently contain certain errors resulting from inaccuracies in their respective measurement techniques, or round-off errors and other common inaccuracies.

Although the present invention has been described in connection with preferred embodiments thereof, it will be appreciated by those skilled in the art that additions, deletions, modifications, and substitutions not specifically described may be made without department from the spirit and scope of the invention as defined in the appended claims. For example, the apparatus and method can include interactive whiteboard, webex, net conference and wiki functionality to enhance the learning and/or teaching experience. Moreover, the apparatus and method can include an interactive mode wherein teachers, students, administrators and/or parents can discuss assignments, tutor students, teach students, and/or provide feedback online.

We claim:

1. A computer implemented method for teaching subject matter comprises:
generating an assignment including one or more questions in an assignment generating station;
providing the assignment to one or more students via a computer implemented testing station;
recording a final answer to each of the one or more questions and one or more steps taken to reach the final answer at the computer implemented testing station; and
grading the assignment at a grading station to produce a graded assignment.

2. The computer implemented method for teaching subject matter of claim 1, further including generating an assignment report at a computer implemented assignment reporting station and optionally providing the assignment report to one or more of a teacher, an administrator and a parent.

3. The method of claim 2, further including adjusting the curriculum based on the assignment report and/or the graded assignment.

4. The method of claim 1, wherein the grading step includes grading the one or more steps take to reach the answer and the final answer.

5. The method of claim 1, further including generating a future performance prediction report at a computer implemented future performance prediction station which can be accessed electronically, sent electronically, and/or printed.

6. The method of claim 5, further including providing a future performance prediction report to one or more of a teacher, an administrator and a parent.

7. The method of claim 5, further including adjusting the curriculum based on the future performance prediction report.

8. The method of claim 1, wherein the assignment is a test, a quiz, homework, a standardized test, or compilation of practice questions.

9. The method of claim 1, wherein the generating step includes uploading a set of questions to an assignment generating station for inclusion in the assignment or selecting a set of questions from an assignment library for inclusion in the assignment.

10. The method of claim 5, wherein the future performance prediction report compares student performance to state and/or national standards and/or one or more planned assignments to determine future performance of a student.

11. The method of claim 1, further including monitoring one or more students during completion of the assignment via an audio-visual recording and/or transmission device.

12. A computer implemented system of teaching subject matter to one or more students comprises:
an assignment generating station operable to generate an assignment including one or more questions;
a testing station operable to administer said assignment to one or more students and record an answer to each of the one or more questions and steps taken to reach the answer; and
a grading station operable to grade each answer and steps taken to reach each answer.

13. The computer implemented system of claim 12, wherein the assignment generating station includes one or more of an assignment library, a personalized assignment library, and an assignment plan.

14. The computer implemented system of claim 12, further including a visualization engine.

15. The computer implemented system of claim 12, further including a missed concepts identifier operable to determine conceptual errors of a student based on answers and steps taken in completing the assignment.

16. The computer implemented system of claim 12, further including an assignment reporting station operable to generate an assignment report and/or a future performance prediction station operable to predict future performance based on the assignment report and/or one or more planned assignments.

17. The computer implemented system of claim 12, further including (a) a curriculum adjustment station operable to adjust student instruction and future assignments and/or (b) a standards database housing state and national standards for comparison to student performance.

18. The computer implemented system of claim 12, further including a personalization engine operable to allow a student to personalize the testing experience.

19. The computer implemented system of claim 12, further including an audio-visual recording and/or transmission device operable to monitor one or more students and/or teachers during completion of an assignment and/or operable to allow viewing of a teacher during instruction.

20. A computer executable program stored on a computer readable medium for use in a computer that provides assignments to students for completion electronically, the computer program product makes the computer execute the process comprising the steps of: generating an assignment including one or more questions in an assignment generating station; providing the assignment to one or more students at a testing station; recording a final answer to each of the one or more questions and one or more steps taken to reach the final answer; and grading the assignment including the final answer and each of the one or more steps at a grading station.
